(19) United States
(12) Patent Application Publication
(10) Pub. No.: US 2019/0291797 A1
(43) Pub. Date: Sep. 26, 2019

(54) CUSTOMIZABLE CHASSIS MODULE WITH INTEGRATED RELATED FUNCTIONS

(71) Applicant: Continental Automotive Systems, Inc., Auburn Hills, MI (US)

(72) Inventors: Thomas Patrick Richards, Royal Oak, MI (US); Jeremy J. McClain, Ortonville, MI (US); Jeremy W. Tuggle, Shelby Township, MI (US); Jörg Scheibel, Lake Orion, MI (US); Ihab Soliman, Washington, MI (US)

(73) Assignee: Continental Automotive Systems, Inc., Auburn Hills, MI (US)

(21) Appl. No.: 16/434,573

(22) Filed: Jun. 7, 2019

Related U.S. Application Data
(63) Continuation of application No. PCT/US2017/065133, filed on Dec. 7, 2017.
(60) Provisional application No. 62/431,162, filed on Dec. 7, 2016.

(51) Int. Cl. B62D 65/04; B62D 65/10; B62D 65/12; B60K 1/00; G05D 1/02

(52) U.S. Cl. CPC B62D 65/04; B62D 65/10; B62D 65/12; B60K 7/0007; G05D 1/0276; G05D 1/0231; B60K 1/00

(57) ABSTRACT

A corner or end module for assembly on a vehicle body comprises a wheel(s), a frame having connection points for removably securing the corner module to the vehicle body, a drive system capable of providing torque to drive the wheel(s), a brake system connected to the wheel(s) capable of braking the wheel(s), a suspension system located between the frame and the wheel(s), a steering system connected to the wheel(s), capable of providing a steering input for the wheel(s), and a communication system capable of communicating from at least one of a drive controller, brake controller, and steering controller of the corner or end module with one of: another corner or end module, a vehicle controller; an autonomous drive controller; another vehicle, infrastructure, and a wireless data server.

### CROSS REFERENCE TO RELATED APPLICATION

The present application claims the benefit of International Application No. PCT/US2017/065133 filed Dec. 7, 2017, which claims priority to U.S. Provisional Application No. 62/431,129, filed on Dec. 7, 2016, each of which is hereby incorporated by reference.

### TECHNICAL FIELD

The disclosure relates to automated driving systems for a motor vehicle, in particular for chassis, braking, steering and associated communications.

### BACKGROUND

The increasing availability of technology has led to automotive vehicle becoming more automated. In particular, safety systems which assist in braking and steering in emergency situations make driving such vehicles safer. Further communications between vehicles, or vehicle and infrastructure is also becoming more popular to provide traffic and safety information to and/or from vehicles.

Vehicle-to-X communications is currently in a phase of development and standardization. This term is understood to mean in particular communication between vehicles (vehicle-to-vehicle communication) and communication between vehicles and infrastructure (vehicle-to-infrastructure communication).

With the increase in technology the driver interaction with the vehicle control systems is decreasing. With fully autonomous guidance the vehicle can maneuver itself independently in traffic and thus completely unburden the driver of the vehicle operation. As these systems become more independent the need to provide HMI and other controls available in the passenger compartment to the driver is less important.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

An end module for assembly on a vehicle body comprising at least two wheels, a frame having connection points for removably securing the end module to the vehicle body, a drive system connected to the wheels and capable of providing torque to drive the wheels, wherein the drive system includes at least a drive controller for controlling an electric motor and an inverter to drive the wheels, a brake system connected to the wheels having a brake controller, an actuator and at least one wheel brake located at each wheel, wherein the brake controller is capable of determining a desired braking action and actuating the actuator apply the wheel brakes to slow rotation of the wheels, a suspension system located between the frame and the at least two wheels, wherein the suspension system provides shock absorption and damping to the frame and vehicle body relative to the wheels, a steering system connected to each of the at least two wheels, wherein the steering system having a steering controller capable of providing a steering input for each of the at least two wheels, and a communication system having a communications module, wherein the communication system is capable of communicating from at least one of the drive controller, brake controller, and steering controller of the end module with one of: another end module, a vehicle controller; an autonomous drive controller; another vehicle, infrastructure, and a wireless data server.

A corner module for assembly on a vehicle body comprising a wheel, a frame having connection points for removably securing the corner module to the vehicle body a drive system connected to the wheel and capable of providing torque to drive the wheel, wherein the drive system includes at least a drive controller for controlling an electric motor and an inverter to drive the wheel, a brake system connected to the wheel having a brake controller, an actuator and a wheel brake located at the wheel, wherein the brake controller is capable of determining a desired braking action and actuating the actuator apply the wheel brake to slow rotation of the wheel, a suspension system located between the frame and the wheel, wherein the suspension system provides shock absorption and damping to the frame and vehicle body relative to the wheel, a steering system connected to the wheel, wherein the steering system having a steering controller capable of providing a steering input for the wheel, and a communication system having a communications module, wherein the communication system is capable of communicating from at least one of the drive controller, brake controller, and steering controller of the end module with one of: another corner module, a vehicle controller; an autonomous drive controller; another vehicle, infrastructure, and a wireless data server.

### BRIEF DESCRIPTION OF THE DRAWINGS

The present disclosure will become more fully understood from the detailed description and the accompanying drawings, wherein:

FIG. 1 shows a schematic exemplary illustration of a first embodiment of a body module and end modules in accordance with one or more embodiments;

FIG. 1A shows a schematic exemplary illustration of a first embodiment of a drive system for a module in accordance with one or more embodiments;

FIG. 1B shows a schematic exemplary illustration of a second embodiment of a drive system for a module in accordance with one or more embodiments;

FIG. 1C shows a schematic exemplary illustration of a third embodiment of a drive system for a module in accordance with one or more embodiments;

FIG. 1D shows a schematic exemplary illustration of a fourth embodiment of a drive system for a module in accordance with one or more embodiments;

FIG. 1E shows a schematic exemplary illustration of a fifth embodiment of a drive system for a module in accordance with one or more embodiments;

FIG. 1F shows a schematic exemplary illustration of a sixth embodiment of a drive system for a module in accordance with one or more embodiments;

FIG. 2A shows a schematic exemplary illustration of a first embodiment of a brake actuation system for a module in accordance with one or more embodiments;

FIG. 2B shows a schematic exemplary illustration of a second embodiment of a brake actuation system for a module in accordance with one or more embodiments;

FIG. 3A shows a schematic exemplary illustration of a first embodiment of a wheel brake system for a module in accordance with one or more embodiments;

FIG. 3B shows a schematic exemplary illustration of a second embodiment of a wheel brake system for a module in accordance with one or more embodiments;

FIG. 3C shows a schematic exemplary illustration of a third embodiment of a wheel brake system for a module in accordance with one or more embodiments;

FIG. 3D shows a schematic exemplary illustration of a fourth embodiment of a wheel brake system for a module in accordance with one or more embodiments;

FIG. 4A shows a schematic exemplary illustration of a first embodiment of a suspension system for a module in accordance with one or more embodiments;

FIG. 4B shows a schematic exemplary illustration of a second embodiment of a suspension system for a module in accordance with one or more embodiments;

FIG. 4C shows a schematic exemplary illustration of a third embodiment of a suspension system for a module in accordance with one or more embodiments;

FIG. 5A shows a schematic exemplary illustration of a first embodiment of a steering system for a module in accordance with one or more embodiments;

FIG. 5B shows a schematic exemplary illustration of a second embodiment of a steering system for a module in accordance with one or more embodiments;

FIG. 5C shows a schematic exemplary illustration of a third embodiment of a steering system for a module in accordance with one or more embodiments;

FIG. 6A shows a schematic exemplary illustration of a first embodiment of a communication system for a module in accordance with one or more embodiments; and

FIG. 6B shows a schematic exemplary illustration of a second embodiment of a communication system for a module in accordance with one or more embodiments.

### DETAILED DESCRIPTION

The following description is merely exemplary in nature and is in no way intended to limit the disclosure, its application, or uses. For purposes of clarity, the same reference numbers will be used in the drawings to identify similar elements.

The Figures illustrate schematic views of exemplary end modules 10 or corner modules 110, which are able independently operable to brake and steer themselves. The end/corner module(s) 10, 110 each have drive systems 12, 112, brake systems 14, 114, suspensions systems 16, steering systems 18 and communication systems 20. The drive system 12, 112, brake systems 14, 114, suspensions systems 16, steering systems 18 and communications systems 20 may be combined with one another in various combinations to form an end module 10 or corner module 110 as described herein.

Both types of modules 10, 110 can be quickly and easily removably secured to a vehicle body module 11. For example, the modules 10, 110 may have a support frame 24 secured to the wheels 22. Components for the drive systems 12, 112, such as a drive controller 26 can be secured and supported on the frame 24, e.g. mounted in the body module fastened by screws or rivets. The end/corner modules 10, 110 are able to provide drive, braking and steering to move a body module 11 which may be attached. In one embodiment the support frame is a space frame design. That is, the frame is tubular or extruded metal, and can be welded or bonded, including steel or aluminum or composite material.

The connection to the body module may be via traditional fasteners, e.g. bolts, nuts, etc. In another embodiment the means for and/or eccentric clamp devices. Additionally, if the end/corner module 10, 110 uses use central hydraulic brakes then we need hydraulic quick connectors may also be used. Alternately the hydraulic brakes are confined to an end module 10, 110 or even to a corner of a corner/end module 10, 110 and hydraulic connections to the body module 11 are not necessary.

The body module 11 may define wheel wells and a compartment to provide space for the modules 10, 110 and may be placed over the modules 11 and secured into position, as in the embodiment shown. Alternately the end portions of the body 10, 110 may be secured to the modules 10, 110 and when assembled joined to the central portion of the body 11 such that the body module 11 does not have to be raised and lowered to assemble with the modules 10, 110. Further, the body module 11 may define storage space that does not interfere with the packaging space for the modules 10, 110. Preferably such storage space could be accessed from the exterior of the vehicle for use by the passengers to store items.

Additionally, the body module 11 (or the portions of the module 11 secured to the end/corner modules 10, 110) have both headlights/tail lights and brake lights such that either end of the vehicle may act as the front or the rear of the vehicle, as discussed in detail below.

The frame 24 or suspension components (discussed below) may have connection points for quickly securing the module 10, 110 to a body module 11. Matching modules 10, 110 can be secured at each end of the body module 11, or at each of the four corners of the body module 11. In this manner, the assembled motor vehicle will have a lead module, located at the forward portion of the vehicle and a follow module located at the rear portion of the vehicle. As both modules 10, 110 are the same either end of the vehicle may be the forward/lead module 10, 110 and may switch back and forth during operation of the vehicle.

The end/corner modules 10, 110 may operate with one another in a lead/follow manner such that the end/corner modules 10, 110 on the front act as the lead and the end/corner modules 10, 110 on the rear are connected and act in a follow mode. When the vehicle changes direction the new end/corner modules 10, 110 will be the front and take the lead, while the other(s) follow. In the lead/follow mode of operation, the lead end/corner modules 10, 110 will be providing all of the necessary wheel torque for vehicle propulsion while the follow end/corner modules 10, 110 will be either disconnected so that no additional drag is provided or will be operated in a neutral (0 torque control) mode. In the case of an end/corner module 10, 110 disconnect, a disconnect clutch (not shown) may be used to mechanically decouple the drive system 12, 112 from the wheels 22. In this way, drag losses from the drive system 12, 112 would be minimized for the end/corner 10, 110 module in the follow mode.

The communication system 20 allows the lead end/corner module(s) 10, 110 to communicate instructions to the follow end/corner module(s) 10, 110 as needed for braking, power, etc. The drive controller determines the ‘lead module’ by the direction the vehicle moves. In an alternative mode of operation, both the end/corner modules 10, 110 on the front and the rear are all providing vehicle propulsion, i.e. the total required wheel torque is distributed among two axles or four wheel, etc. This mode of operation would primarily be used in a high wheel torque demand scenario such as driving up a hill, i.e. steep road grades. In yet another mode of operation, both the front and rear end/corner modules 10, 110 may be providing propulsion but not necessarily in equal levels to achieve optimum efficiency. In other words, the distribution of propulsion between front and rear may be determined based on best operating efficiency and consideration of vehicle stability events.

The end/corner module(s) 10, 110 will require sensor input to provide the autonomous instructions for driving, braking and steering themselves. Various cameras and sensors may be connected to a controller for determining the autonomous driving instructions. The sensors, cameras and controller may be mounted on and included in the end/corner module(s) 10, 110 or may be mounted on the body and communicate the various instructions to the necessary systems 12, 112, 14, 114, 16, 18 and 20 on the end/corner module(s) 10, 110. Redundant sensing and communication can be provided for safety between the autonomous controller and the drive 12, 112 brake 14, 114 and steering systems 16 of the end/corner module(s) 10, 110.

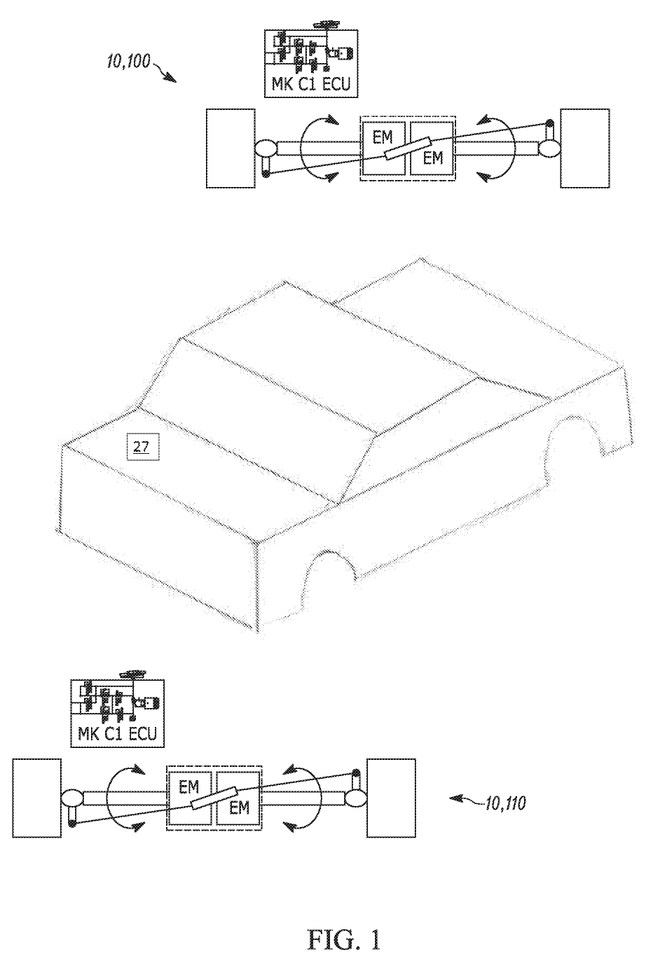

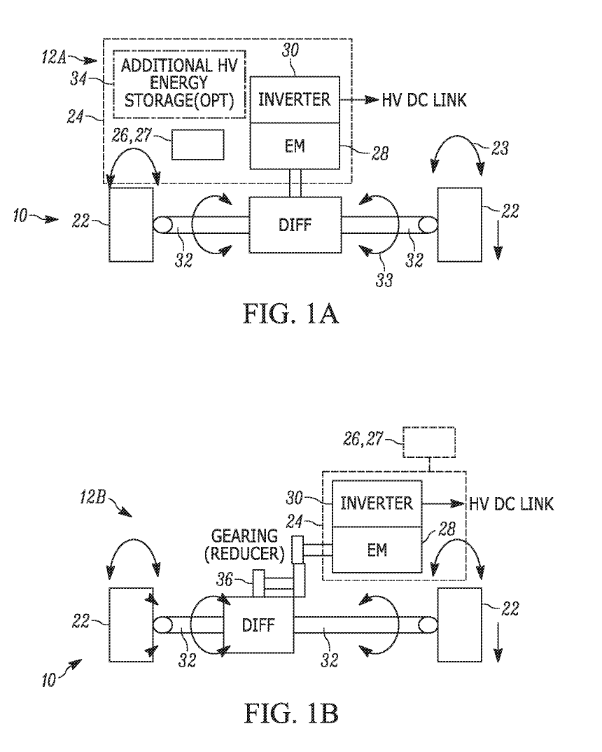

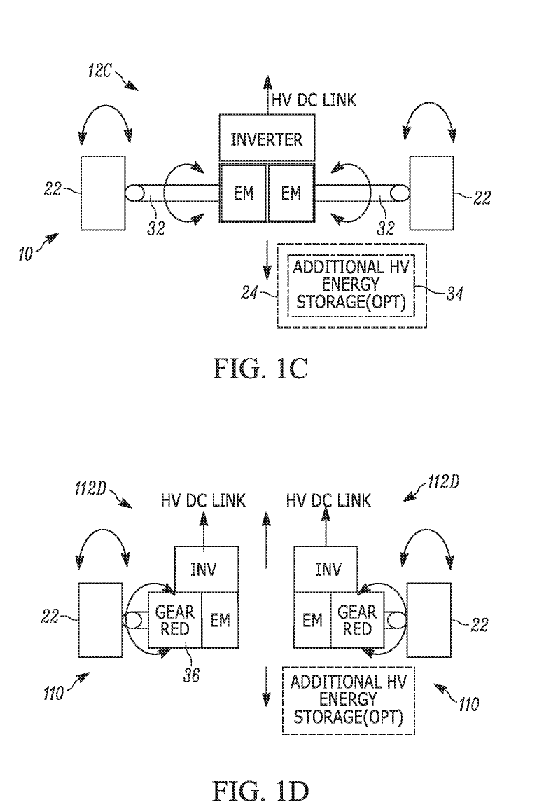

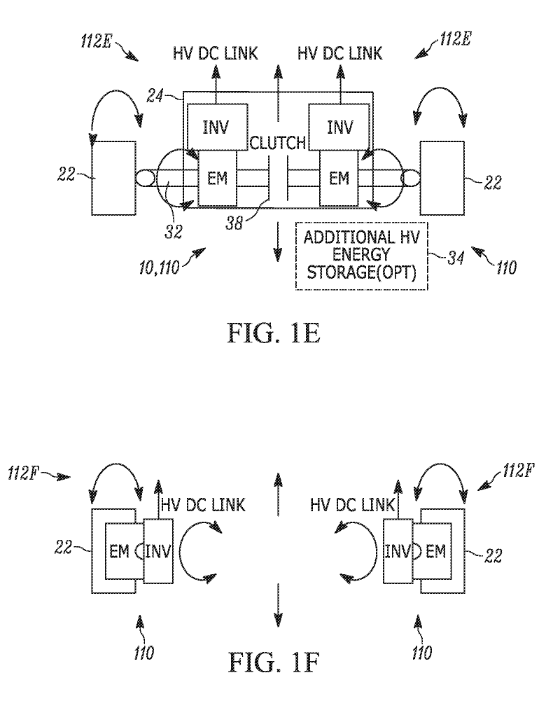

FIG. 1A shows a first embodiment of a drive system 12A for an end module 10 where the drive system 12A includes an electric machine (EM) 28 with an integrated inverter 30 connected to drive a differential 35, which is connected to two wheel assemblies 22 through drive shafts 32. The inverter 30 may be connected to a high voltage DC link to provide power to the electric machine 28. Additional high voltage energy storage 34 may also be available. The electric machine 28, inverter 30, and additional energy storage 34 may all be supported by the frame 24. As indicated by the arrows 23 and 33 the wheels 22 and drive shafts 32 may be driven to rotate in either direction. The drive controller 26 (or vehicle controller 27) will decide either one drive module from front or rear while the other operates in a follow mode OR both front and rear end/corner modules 10, 110 operate to provide propulsion. The decision is made based on desired vehicle direction, total vehicle propulsion torque demand (i.e. higher the torque demand may require both front and rear to drive for example on a road grade/hill). The decision is also made based on operating efficiency of front vs. rear and in addition based on vehicle stability/ESP limits to prevent wheel slip for traction. The driving module decision may also be changed in the case of overheating or failure of one of the end/corner modules 10, 110.

FIG. 1B shows a second embodiment of a drive system 12B for an end module 10 where the drive system 12B includes an electric machine 28 with an integrated inverter 30 connected through a reduction gear set 36 to drive a differential 35, which is connected to two wheel assemblies 22 through drive shafts 32. The inverter 30 may be connected to a high voltage DC link to provide power to the electric machine 28. Additional high voltage energy storage 34 may also be available (not shown). The electric machine 28, inverter 30, and additional energy storage 34 may all be supported by the frame 24. As indicated by the arrows 23 and 33 the wheels 22 and drive shafts 32 may be driven to rotate in either direction.

FIG. 1C shows a third embodiment of a drive system 12C for an end module 10 where the drive system 12C includes two electric machines 28 with an inverter 30 to drive two wheel assemblies 22 through drive shafts 32. The electric machines 28 may be two rotors in one stator. The inverter 30 may be connected to a high voltage DC link to provide power to the electric machine 28. Additional high voltage energy storage 34 may also be available. The electric machine 28, inverter 30, and additional energy storage 34 may all be supported by the frame 24. As indicated by the arrows 23 and 33 the wheels 22 and drive shafts 32 may be driven to rotate in either direction. The drive shafts 32 are each directly driven by one of the electric motors 28.

FIG. 1D shows a fourth embodiment of a drive system 12D for corner modules 110 where the drive system 112D for each corner includes an electric machine 28 with an inverter 30 to drive the wheel assembly 22 through drive shaft 32. The inverter 30 may be connected to a high voltage DC link to provide power to the EM 28. Additional high voltage energy storage 34 may also be available. EM 28, inverter 30, and additional energy storage 34 may all be supported by the frame 24. As indicated by the arrows 23 and 33 the wheel 22 and drive shaft 32 may be driven to rotate in either direction. The EM 28 is connected to the wheel 22 through a gear reducer set 36.

FIG. 1E shows a fifth embodiment of a drive system 12E for corner modules 110 where the drive system 112E for each corner includes an electric machine 28 with an inverter 30 to drive the wheel assembly 22 through drive shaft 32. The inverter 30 may be connected to a high voltage DC link to provide power to the EM 28. Additional high voltage energy storage 34 may also be available. EM 28, inverter 30, and additional energy storage 34 may all be supported by the frame 24. As indicated by the arrows 23 and 33 the wheel 22 and drive shaft 32 may be driven to rotate in either direction. Two corner modules 110 can be connected to one another through a clutch 38. The clutch 38 may be supported on the frame 24 for one of the corner modules 110, while the other corner module 110 may include the necessary linkage to connect the two drive systems 112E to one another.

FIG. 1F shows a fourth embodiment of a drive system 12F for corner modules 110 where the drive system 112F for each corner includes an electric machine 28 with an inverter 30 to drive the wheel assembly 22. The inverter 30 may be connected to a high voltage DC link to provide power to the EM 28. Additional high voltage energy storage 34 may also be available (not shown). The EM 28, inverter 30, and additional energy storage 34 may all be supported by the frame 24. As indicated by the arrows 23 the wheel 22 may be driven to rotate in either direction. The wheel 22 is directly driven by one of the electric motor 28.

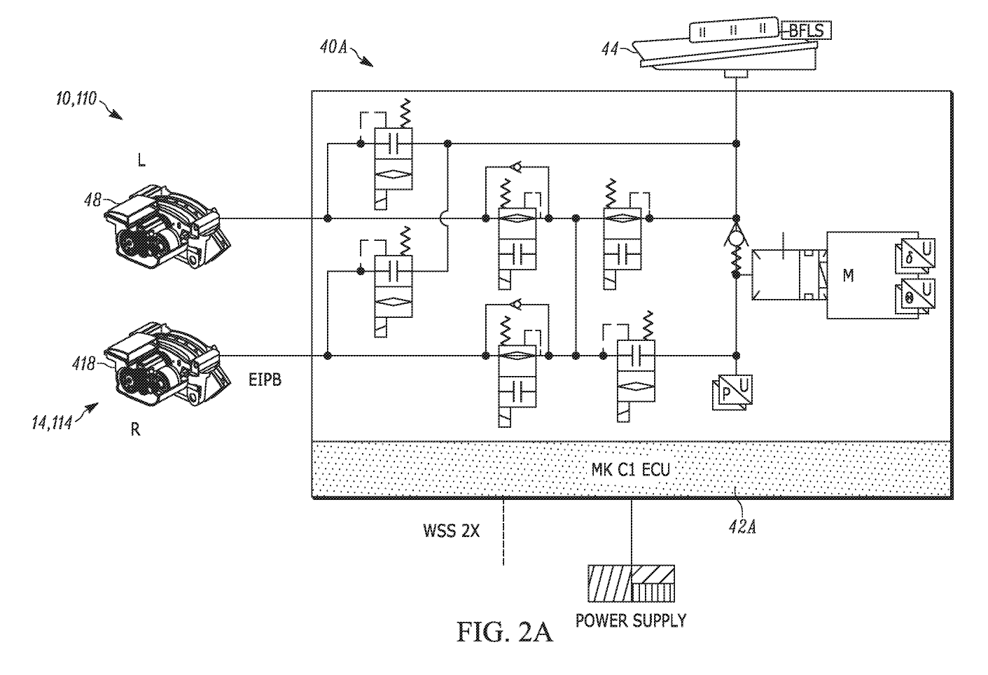

FIG. 2A shows a first schematic illustration of a brake system 14, 114 for end/corner module(s) 10, 110. The brake system 14, 114 has an electro-hydraulic actuation system 40A with a controller 42 and a fluid reservoir 44. The brake system 14, 114 is connected to a power supply and a wheel speed sensor for each wheel 22. An Electric Integrated Parking Brake (EiPB) 46 is included in the brake system 14, 114. For end modules 10, a second wheel brake 48 may also be included on the second wheel 22 of the end module 10. The second wheel brake 48 may be conventional or NWC style wheel brake(s).

In one embodiment each deceleration brake event is analyzed by the brake controller and then the brake controller decides what deceleration device e.g. EM regeneration, friction brake, EPB, etc., should be used to satisfy the deceleration request. For example, possibly only the EM regenerative braking is used primarily in order to extend range of the vehicle, and friction brakes are only additionally used if necessary to reach the required deceleration. Depending on speed and deceleration request only one module may be sufficient or both modules are used to complete the request.

FIG. 2B shows a second schematic illustration of a brake system 14B, 114B for end/corner module(s) 10, 110. The brake system 14, 114 has an electro-mechanical actuation system 40B with a controller 42. The brake system 14, 114 is connected to a power supply and a wheel speed sensor for each wheel 22. A wheel brake 48 may be conventional or NWC style wheel brake(s).

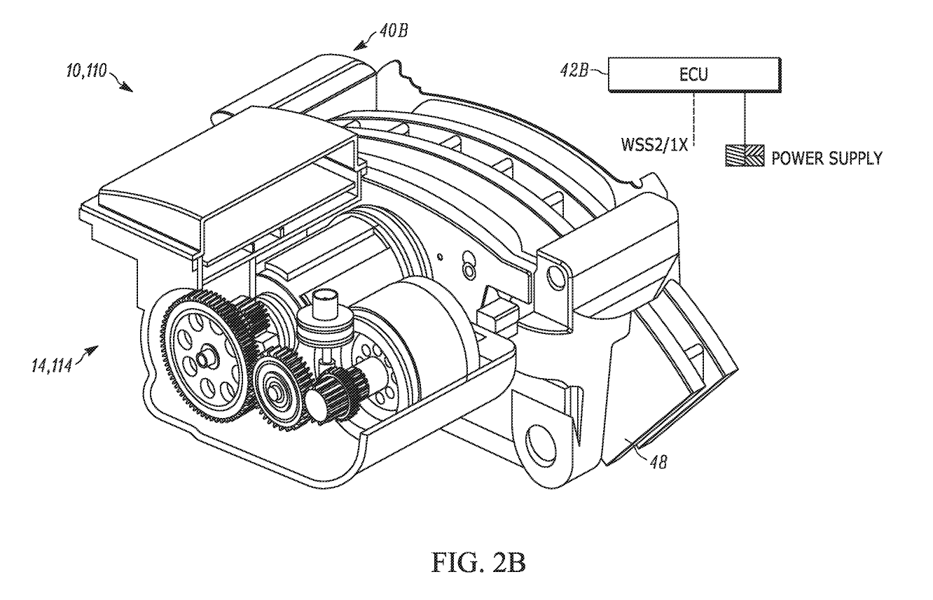

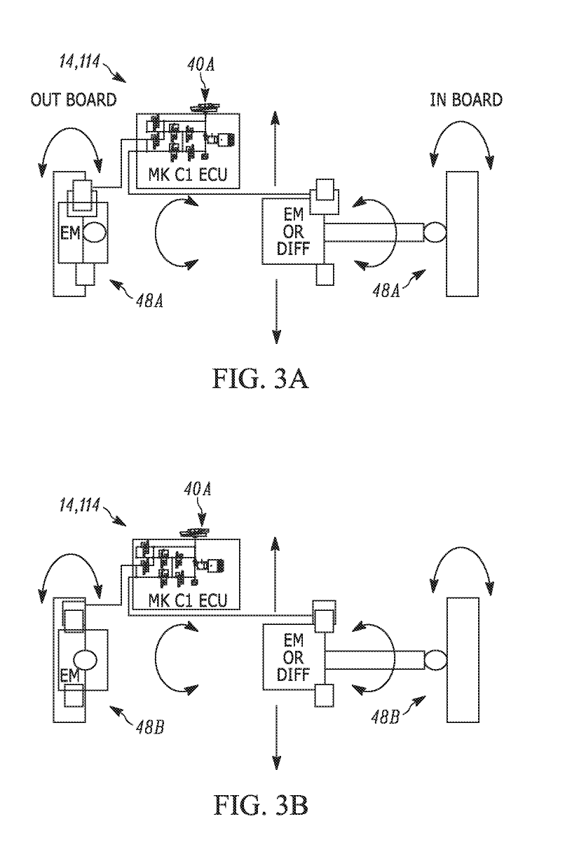

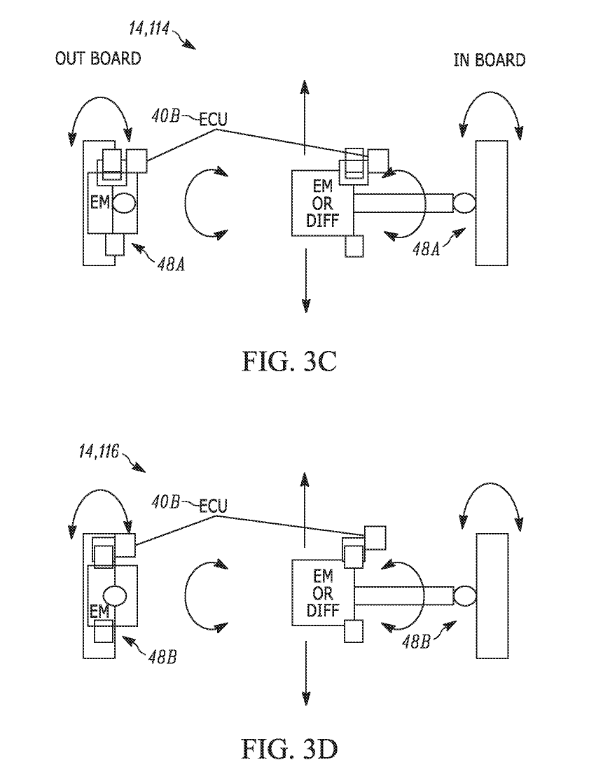

FIG. 3A shows a first schematic illustration of brakes 48A for a brake system 14, 114 for end/corner module(s) 10, 110. The brake system 14, 114 has an electro-hydraulic actuation system 40A with a controller 42 and a fluid reservoir 44. A wheel brake 48 may also be included on the each wheel 22. The wheel brake 48 may be a tall narrow system with NWC style wheel brake(s).

FIG. 3B shows a second schematic illustration of brakes 48A for a brake system 14, 114 for end/corner module(s) 10, 110. The brake system 14, 114 has an electro-hydraulic actuation system 40A with a controller 42 and a fluid reservoir 44. A wheel brake 48 may also be included on the each wheel 22. The wheel brake 48 may be a conventional rotor and caliper style wheel brake(s) 48B.

FIG. 3C shows a third schematic illustration of brakes 48C for a brake system 14, 114 for end/corner module(s) 10, 110. The brake system 14, 114 has an electro-mechanical actuation system 40B with a controller 42. A wheel brake 48 is included on the each wheel 22. The wheel brake 48 may be a tall narrow system with NWC style wheel brake(s).

FIG. 3D shows a fourth schematic illustration of brakes 48D for a brake system 14, 114 for end/corner module(s) 10, 110. The brake system 14, 114 has an electro-mechanical actuation system 40B with a controller 42. A wheel brake 48 is included on the each wheel 22. The wheel brake 48 may be a conventional rotor and caliper style wheel brake(s) 48B.

The modules 10, 110 proposed would total chassis and powertrain systems to be provided in customizable modules having all the necessary functions available for integration, including Brake systems, Suspension Systems, Powertrain (Electric Traction Drive), Telematics, Transportation Services, Power Distribution, Tires and Tire Information Systems, Hoses, Tubes, Isolation devices as well as, axels , drive shafts, structural connections, and steering Components. This will allow the body module to focus customer/driver specific experience factors, while delegating responsibility for the propulsion and lateral actuation of a vehicle to the end/corner modules 10, 110. Additionally both modules may be identical and provide the same functions. This is additionally satisfies any safety requirements relating to redundancy of components, such as brake system components.

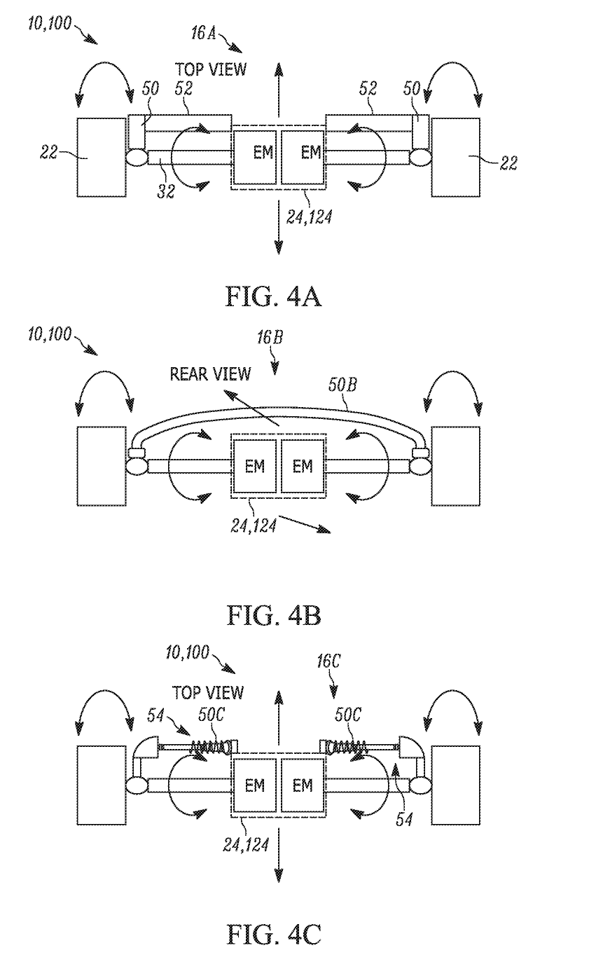

FIG. 4A shows a first embodiment of a suspension system 16A for an end/corner module 10, 110 where the suspension system 16A includes a torsion spring 50 and a horizontally mounted shock absorber 52 which are connected between the wheel 22 and the frame 24 with the EM 28 and other components mount thereon. Horizontal mounting of the shock absorber 52 provides for a low packaging profile for the end/corner module 10, 110 which may be helpful when assembling/disassembling and otherwise packaging the end/corner module(s) 10, 110 to the body 11 (not shown). Since the modules are connected to the body, they provide suspension for the body module and themselves

FIG. 4B shows a second embodiment of a suspension system 16B for an end/corner module 10, 110 where the suspension system 16A includes a leaf spring 50B and a horizontally mounted shock absorber(s) 52 which are connected between the wheel 22 and the frame 24 with the EM 28 and other components mount thereon. The leaf spring 50B may be a single or divided leaf spring 50B. Horizontal mounting of the shock absorber(s) 52 provides for a low packaging profile for the end/corner module 10, 110 which may be helpful when assembling/disassembling and otherwise packaging the end/corner module(s) 10, 110 to the body 11 (not shown).

FIG. 4C shows a third embodiment of a suspension system 16C for an end/corner module 10, 110 where the suspension system 16C includes horizontally mounted struts 54 which are connected between the wheel 22 and the frame 24 with the EM 28 and other components mount thereon. Horizontal mounting of the shock strut(s) 54 provides for a low packaging profile for the end/corner module 10, 110 which may be helpful when assembling/disassembling and otherwise packaging the end/corner module(s) 10, 110 to the body 11 (not shown). The strut(s) 54 may include an air spring or coil spring 50C.

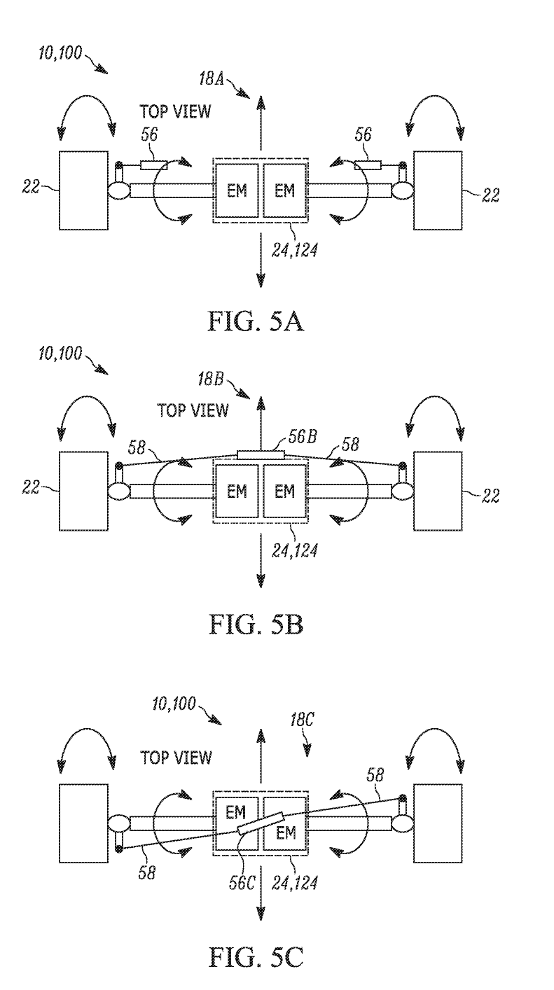

FIG. 5A shows a first embodiment of a steering system 18A for an end/corner module 10, 110 where the steering system 16A includes individual el. actuators 56 connected to wheel 22 on an outboard side of the frame connection, such as a drive shaft 32. The actuator 56A allows each wheel to be steered individually. The actuators may each have their own control 40, or may have one controller 40 that communicates to the actuators 56A of the other wheels 22.

FIG. 5B shows a second embodiment of a steering system 18B for an end module 10 where the steering system 16B includes a conventional el. actuator 56 mounted on an inboard side of the frame connection at the EM(s) 28. The actuator 56 is connected to the wheels 22 through linkages 58. The actuator 56 may also include a controller 40 (not shown).

FIG. 5C shows a third embodiment of a steering system 18C for an end module 10 where the steering system 16C includes an el. actuator 56C mounted on an inboard side of the frame connection at the EM(s) 28. The actuator 56C is independent of drive direction of the wheels 22. The actuator 56C is connected to the wheels 22 through linkages 58. The actuator 56 may also include a controller 40 (not shown).

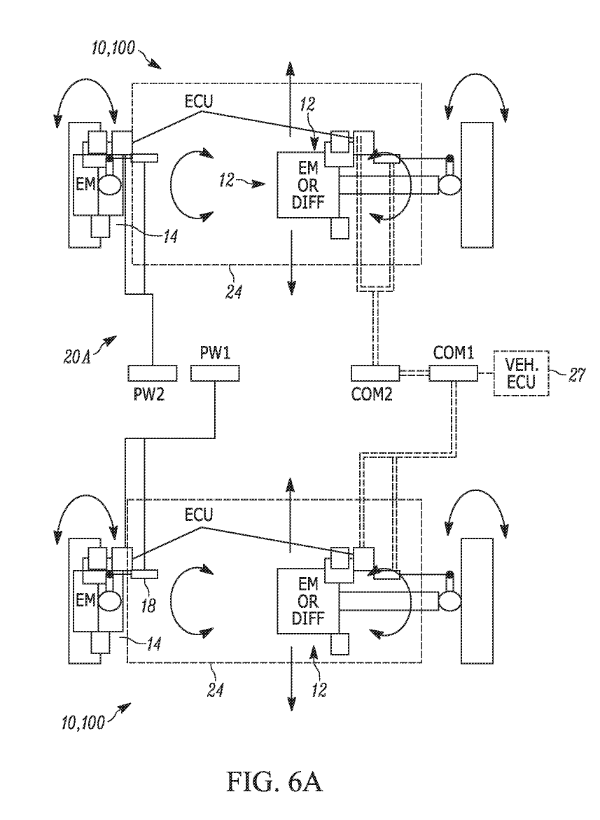

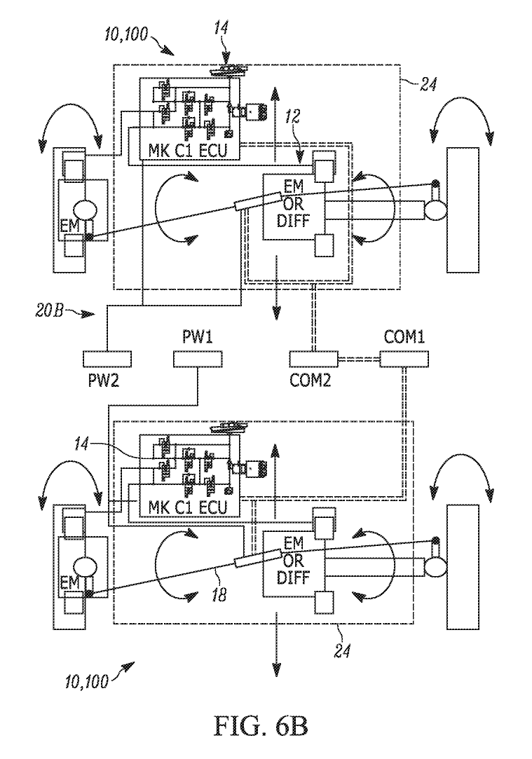

FIG. 6A shows a first embodiment of a communication system 20A for an end/corner module(s) 10, 110 the communications system 20A can provide for sending and receiving information for two end modules 10, or four corner modules 110 mounted to one vehicle body 11. The lead end/corner module(s) 10, 110 can direct the various systems of the follow end/corner module(s) 10, 110 with the necessary instructions for providing vehicle functions. For example, for a brake system 12 (electro-mechanical system 14B shown) the ECU 40 for the lead end/corner module(s) 10, 110 may determine the braking necessary and communicated to the ECU 40 for the follow end/corner module(s) 10, 110 the necessary braking instructions. Similarly, the drive systems 12, 112 and steering systems 18 (individual actuators 56A shown) may also provide communications between the end/corner module(s) 10, 110. The communication system can be a Controller Area Network (CAN) based or Ethernet based system running on 12 Volts or 48 Volts. The drive systems 12, 112, brake systems 14, 114, and steering systems 18 can have common or individual controllers 40 (individual shown). The communications system 20A connects the controllers 40 for each end/corner module 10, 110 to one another. Further, if necessary the communication system 20A may also be capable of handling communication between the end/corner module(s) 10, 110 and other vehicles or infrastructure, V to X communications. Preferably both drive modules as well as the body module are connected to the same CAN or Ethernet. With that they can exchange information and the connection to the infrastructure is accomplished via wireless communication, i.e. cellular.

FIG. 6B shows a second embodiment of a communication system 20B for an end/corner module(s) 10, 110 the communications system 20B can provide for sending and receiving information for two end modules 10, or four corner modules 110 mounted to one vehicle body 11. The lead end/corner module(s) 10, 110 can direct the various systems of the follow end/corner module(s) 10, 110 with the necessary instructions for providing vehicle functions. For example, for a brake system 12 (electro-hydraulic system 14A shown) the ECU 40 for the lead end/corner module(s) 10, 110 may determine the braking necessary and communicated to the ECU 40 for the follow end/corner module(s) 10, 110 the necessary braking instructions. Similarly, the drive systems 12, 112 and steering systems 18 (drive independent conventional actuator 56C shown) may also provide communications between the end/corner module(s) 10, 110. The communication system can be a CAN based or Ethernet based system running on 12 Volts or 48 Volts. The drive systems 12, 112, brake systems 14, 114, and steering systems 18 can have common or individual controllers 40 (individual shown).

Therefore, an end/corner module 10, 110 can be built in a modular manner by selecting one of the drive systems 12, 112 one of the brake systems 14, 114 one of the suspensions systems 16, one of the steering systems 18 and one of the communication systems 20 and assembling them together on a frame 24 with the wheel(s) 22. The end/corner module(s) 10, 110 will be independently operable from one another to autonomously drive, brake and steer themselves. One or more end/corner module(s) 10, 110 may be assembled onto a body 11 to create a vehicle that can be autonomously controlled by the end/corner module(s) 10, 110.

Vehicles today have these components designed and purchased separately by OEMs, or in some limited combination thereof. By offering the end module or corner module 10, 110 as a single comprehensive assembly, OEMs will now have the opportunity to order substantial functional components as a single ‘bundle’. The critical chassis, powertrain and communications components can be included into modules that can implemented in different configurations. End modules 10 can include tires, wheels, brake actuation components, air suspension components, electric traction drive, steering actuators, linkages, along with the relevant sensors and control electronics. These modules 10 would be implemented on the front or rear of a vehicle. Corner modules 110 can include tires, wheels, brake actuation components, air suspension components, electric traction drive, steering actuators, linkages, along with the relevant sensors and control electronics. These modules 110 would be implemented for the corners of the vehicle.

Service could be by either swapping out worn components and or modules, outside of dealership as a convenience for end users. Data collected through various sensorics and or algorithms regarding the performance of components to improve their features and functions. Such customizable modules 10, 110 enables proactive preventive maintenance of components via prognostic capabilities and improves serviceability of components. Components may be serviced by replacing a module 10, 110 for service off line, while continuing to allow the vehicle to operate. By keeping the end module or corner module concept, there is considerably more flexibility and component interchangeability in the implementation.

The corner module and end module will allow for repair and replacement of complete modules in a very fast so that they can quickly be returned to service. Due to flexibility the end and corner modules 10, 110 provide various levels of performance by swapping out components to achieve different results (swapping out a relatively weaker electric motor traction drive in favor of a relatively stronger one in order to achieve improved performance).

The invention is not limited to the exemplary embodiment described above. To a far greater extent, other variants of the invention can be derived by persons skilled in the art without departing from the object of the invention. In particular, all individual features described in connection with the exemplary embodiment can also be combined in other ways with each other without departing from the object of the invention.

What is claimed is:

1. An end module for assembly on a vehicle body comprising:
at least two wheels;
a frame having connection points for removably securing the end module to the vehicle body;
a drive system connected to the wheels and capable of providing torque to drive the wheels, wherein the drive system includes at least a drive controller for controlling an electric motor and an inverter to drive the wheels;
a brake system connected to the wheels having a brake controller, an actuator and at least one wheel brake located at each wheel, wherein the brake controller is capable of determining a desired braking action and actuating the actuator apply the wheel brakes to slow rotation of the wheels;
a suspension system located between the frame and the at least two wheels, wherein the suspension system provides shock absorption and damping to the frame and vehicle body relative to the wheels;
a steering system connected to each of the at least two wheels, wherein the steering system having a steering controller capable of providing a steering input for each of the at least two wheels; and
a communication system having a communications module, wherein the communication system is capable of communicating from at least one of the drive controller, brake controller, and steering controller of the end module with one of:
another end module, a vehicle controller; an autonomous drive controller; another vehicle, infrastructure, and a wireless data server.

2. The end module of claim 1, wherein at least two of the drive controller, brake controller, steering controller and communications module are part of the same controller.

3. The end module of claim 1, wherein the drive controller, brake controller, and steering controller receive instructions from an autonomous drive controller to control the end module to provide autonomous driving actions.

4. The end module of claim 3, wherein the autonomous drive controller is connected to a plurality of sensor, camera and lidar inputs to receive data about an environment surrounding the end module.

5. The end module of claim 3, wherein the autonomous drive controller is located on the vehicle body.

6. The end module of claim 1, wherein there is a second end module removably secured to an opposing end of the vehicle body.

7. The end module of claim 6, wherein one of the end module and the second end module are a lead end module and the other of the end module and the second end module are a follow end module.

8. The end module of claim 7, wherein the lead end module and the follow end module are based on the drive direction of the end modules and the vehicle body, and wherein the lead module and the follow module may switch when the drive direction is reversed.

9. A corner module for assembly on a vehicle body comprising:
a wheel;
a frame having connection points for removably securing the corner module to the vehicle body;
a drive system connected to the wheel and capable of providing torque to drive the wheel, wherein the drive system includes at least a drive controller for controlling an electric motor and an inverter to drive the wheel;
a brake system connected to the wheel having a brake controller, an actuator and a wheel brake located at the wheel, wherein the brake controller is capable of determining a desired braking action and actuating the actuator apply the wheel brake to slow rotation of the wheel;
a suspension system located between the frame and the wheel, wherein the suspension system provides shock absorption and damping to the frame and vehicle body relative to the wheel;
a steering system connected to the wheel, wherein the steering system having a steering controller capable of providing a steering input for the wheel; and
a communication system having a communications module, wherein the communication system is capable of communicating from at least one of the drive controller, brake controller, and steering controller of an end module with one of:
another corner module, a vehicle controller; an autonomous drive controller; another vehicle, infrastructure, and a wireless data server.

10. The corner module of claim 9, wherein at least two of the drive controller, brake controller, steering controller and communications module are part of the same controller.

11. The corner module of claim 9, wherein the drive controller, brake controller, and steering controller receive instructions from an autonomous drive controller to control the corner module to provide autonomous driving actions.

12. The corner module of claim 11, wherein the autonomous drive controller is connected to a plurality of sensor, camera and lidar inputs to receive data about the environment surrounding the corner module.

13. The corner module of claim 11, wherein the autonomous drive controller is located on the vehicle body.

14. The corner module of claim 9, wherein there is a second corner module removably secured to an opposing corner at the same end of the vehicle body, and there are third and fourth corner module removably secure to opposing corners at the opposing end of the vehicle body.

15. The corner module of claim 14, wherein at least one of the first and second corner modules and the third and fourth corner modules are a lead corner module and the module located on an opposing end of the vehicle body are follow corner modules.

16. The corner module of claim 15, wherein the lead corner module and the follow corner modules are based on the drive direction of the corner modules and the vehicle body, and wherein the lead module and the follow modules may switch when the drive direction is reversed.
